(19) United States
(12) Patent Application Publication
(10) Pub. No.: US 2015/0218720 A1
(43) Pub. Date: Aug. 6, 2015

(54) PROCESS FOR TREATING MAGNESIUM-BEARING ORES

(71) Applicant: ORBITE ALUMINAE INC., St.Laurent (CA)

(72) Inventors: François Picard, Quebec (CA); Joël Fournier, Chambly (CA)

(21) Appl. No.: 14/422,111

(22) PCT Filed: Aug. 26, 2013
(86) PCT No.: PCT/CA2013/050659

§ 371 Date: Feb. 17, 2015

Related U.S. Application Data
(60) Provisional application No. 61/693,205, filed on Aug. 24, 2012.
(60) Provisional application No. 61/745,167, filed on Dec. 21, 2012.

(51) Int. Cl. C25C 3/04; C22B 3/10; C22B 3/00; C01G 49/06; C22B 3/42; C25C 7/06; C22B 26/20; C01G 49/08; C22B 3/44; C22B 4/02; C22B 4/04; C22B 21/00; C22B 26/22; C22B 3/46

(52) U.S. Cl. CPC C25C 3/04; C22B 26/22; C22B 3/10; C22B 23/0461; C01G 49/06; C22B 3/42; C22B 3/46; C22B 26/20; C01G 49/08; C22B 3/44; C22B 4/02; C22B 4/04; C22B 21/0015; C25C 7/06

(57) ABSTRACT

It is described a process for extracting magnesium from magnesium-bearing materials comprising the steps of leaching the magnesium-bearing material with HCl as to obtain a leachate comprising the magnesium in solution and a solid form; purify said leachate to produce magnesium chloride and electrolysing the magnesium chloride producing magnesium metal.

### TECHNICAL FIELD

The present disclosure relates to the extraction of magnesium from magnesium-bearing ores using hydrochloric acid. The process encompassed is useful for extracting magnesium from magnesium-bearing ores comprising other metals such as Si, Ni, and Fe and minimizing the lost in hydrochloric acid.

### BACKGROUND ART

Asbestos is a set of six naturally occurring silicate minerals used commercially for their desirable physical properties. They all have in common their eponymous, asbestiform habit: long and thin fibrous crystals. Asbestos became increasingly popular among manufacturers and builders in the late 19th century because of its sound absorption, average tensile strength, its resistance to fire, heat, electrical and chemical damage, and affordability. It was used in such applications as electrical insulation for the 19th century. For a long time, the world's largest asbestos mine was the Jeffrey mine in the town of Asbestos, Quebec.

The chemistry of asbestos tailings is complex. The discarded serpentine tailings from asbestos mining are being mined themselves for magnesium. The tailings contain 24% magnesium and represent a valuable opportunity for metal extraction. Presently, to extract the magnesium, the thermal Piegon process is generally used. Thermal lessening of magnesium oxide is also used for extracting magnesium from ores.

Magnesium is a commercially important metal with many uses. It is only two thirds as dense as aluminum. It is easily machined, cast, forged, and welded. It is used extensively in alloys, with aluminum and zinc, and with manganese. Magnesium compounds are used as refractory material in furnace linings, producing metals (iron and steel, nonferrous metals), glass and cement. It is further used in airplane and missile construction. It also has many useful chemical and metallurgic properties, which make it appropriate for many other non-structural applications.

Taking out the magnesium metal from unrefined materials is a force exhaustive procedure requiring nicely tuned technologies. There is thus still a need to be provided with improved processes for extracting magnesium from magnesium-bearing ores such as asbestos.

### SUMMARY

In accordance with the present description there is now provided a process for extracting magnesium metal from a magnesium-bearing material, the process comprising leaching the magnesium-bearing material with HCl as to obtain a leachate and electrolyzing said leachate for producing magnesium metal.

Particularly, the process described herein comprises the step of electrolyzing the leachate comprising magnesium chloride to obtain magnesium metal.

In an embodiment, the process comprises the step of dehydrating magnesium chloride contained in the leachate in a two step fluidized bed before the step of electrolyzing the magnesium chloride to obtain magnesium metal.

In an embodiment, a two step fluidized bed is used for dehydrating the magnesium chloride.

In another embodiment, the process described herein further comprises a drying step in a fluidized bed dryer followed by gaseous HCl drying to extract anhydrous magnesium chloride.

In a further embodiment, the dehydrated magnesium chloride is further dissolved in molten salt electrolyte.

In another embodiment, dry hydrochloric acid is added to proceed with the dehydration step.

In an embodiment, the electrolyzing step of the magnesium chloride comprises using an electrolysis cell having a cathode and an anode wherein a source of hydrogen gas is delivered to the anode.

In an embodiment, the process described herein further comprises recycling the gaseous HCl by contacting it with water so as to obtain a composition having a concentration of about 20 to about 45 weight % and using the composition for leaching.

In an embodiment, the magnesium-bearing material is leached with HCl having a concentration of about 20 to about 45 weight % at a temperature of about 60 to about 125° C., more particularly at a temperature of 80° C.

In a preferred embodiment, the recycled gaseous HCl so-produced is contacted with water so as to obtain the composition having a concentration between 25 and 36 weight %.

In a further embodiment, the process described herein further comprises a step of separating silica from the leachate.

In a further embodiment, the process described herein further comprises the step of passing the leachate on a chelating resin system to recuperate nickel chloride from the leachate.

Preferably, the chelating resin system can be a DOWEX™ M4195 chelating resin.

In a further embodiment, the process described herein further comprises the step of electrolyzing the nickel chloride to obtain nickel.

In a further embodiment, the process described herein further comprises the step of hydrolysis at a temperature of about 155 to about 350° C. the leachate to extract hematite.

In a further embodiment, the process described herein further comprises the step of passing the hydrolyzed leachate on a chelating resin system to recuperate nickel chloride from the hydrolyzed leachate.

Preferably, HCl of at least 15% concentration can be regenerated.

In another embodiment, the process described herein further comprises the step of supplementing at least one of MgCO₃, H₂SO₄, and MgSO₄ to the leachate and purifying said supplemented leachate to recuperate CaCO₃ and/or CaSO₄.

In a further embodiment, the process described herein further comprises the step of separating a liquid phase from the solid form and concentrating the liquid phase to a concentrated liquid having an iron chloride concentration of at least 30% by weight; and then the iron chloride is hydrolyzed at a temperature of about 155 to about 350° C. while maintaining a ferric chloride concentration at a level of at least 65% by weight, to generate a composition comprising a liquid and precipitated hematite, and recovering the hematite.

The Na₂SO₄ can be precipitated by reacting the liquid with H₂SO₄.

In a further embodiment, the process described herein further comprises reacting the liquid with HCl, and substantially selectively precipitating K₂SO₄.

In another embodiment, the process comprises separating the solid form from the leachate and washing the solid so as to obtain silica having a purity of at least 90%.

In an embodiment, the process is a semi-continuous process.

In another embodiment, the process is a continuous process.

In a further embodiment, the process is effective for recovering SiO₂.

In an embodiment, the process is effective for recovering Fe₂O₃.

In a further embodiment, the process is effective for providing a HCl recovery yield of at least 90%.

In another embodiment, the magnesium-bearing material is a magnesium-bearing ore, such as for example, magnesite, brucite, talc, chrysotile or a mixtures thereof.

In a preferred embodiment, the magnesium-bearing material is a tailing, such as for example an asbestos mine tailing.

In an embodiment, the asbestos tailing contains silica, magnesium, iron and/or nickel.

In a further embodiment, the asbestos tailing further contains Na, K, Ca, Cr, V, Ba, Cu, Mn, Pb, and/or Zn.

In another embodiment, the asbestos tailing comprises about 30 to about 40% by weight of MgO, about 0.1 to about 0.38% by weight Ni, about 32 to about 40% by weight of SiO₂.

In a further embodiment, the process described further comprises a step of magnetic separation of the magnesium-bearing material before step a) of leaching to recover magnetite.

In a further embodiment, the process described further comprises the step of oxidizing leachate and crystallizing said leachate to recover Fe₂O₃ and AlCl₃.

In a supplemental embodiment, the process described further comprises the step of supplementing at least one of Mg(CO₃)₂, H₂SO₄, and MgSO₄ to the leachate and purifying said supplemented leachate to recuperate purified Ca(CO₃)₂ and/or Ca(SO₄).

### BRIEF DESCRIPTION OF THE DRAWINGS

Reference will now be made to the accompanying drawings, showing by way of illustration:

FIG. 1 shows a bloc diagram of a process according to one embodiment for extracting magnesium from a magnesium-bearing ore.

FIG. 2 shows a block diagram of a process according to another embodiment for extracting magnesium from a magnesium-bearing ore.

### DETAILED DESCRIPTION

It is provided a process for extracting magnesium mineral from magnesium-bearing ores using hydrochloric acid which is recycle during the process.

The principal magnesium-bearing ores are magnesite (MgCO₃) and brucite (Mg(OH)₂) which are traditionally mined and processed by flotation and other physical separation techniques. Other ores, such as talc and chrysotile, are mined and hand-graded to get sufficient purity for commercial use.

The process of the present disclosure can be effective for treating various magnesium-bearing ores such as for example, and not limited to, magnesite, brucite, talc and chrysotile, or mixtures thereof which can be used as starting material.

After the process of separating the valuable fraction from the uneconomic fraction (gangue) of an ore, tailings are left over. Tailings, also called mine dumps, culm dumps, slimes, tails, refuse, leach residue or slickens, are the materials left over which can be trated by the process described herein.

The expression “Asbestos Mine tailing” as used herein refers to an industrial waste product generated during the production of asbestos. For example, such a waste product can contain silica, magnesium, iron, nickel. It can also contain an array of minor constituents such as Na, K, Ca, Cr, V, Ba, Cu, Mn, Pb, Zn, etc. For example, Asbestos tailing can comprises about 30 to about 40% by weight of MgO, about 0.1 to about 0.38% by weight of Ni, about 32 to about 40% by weight of SiO₂.

The process describe herein allows processing and extracting magnesium from tailing, such as asbestos mine tailing, obtained after processing of magnesium-bearing ores.

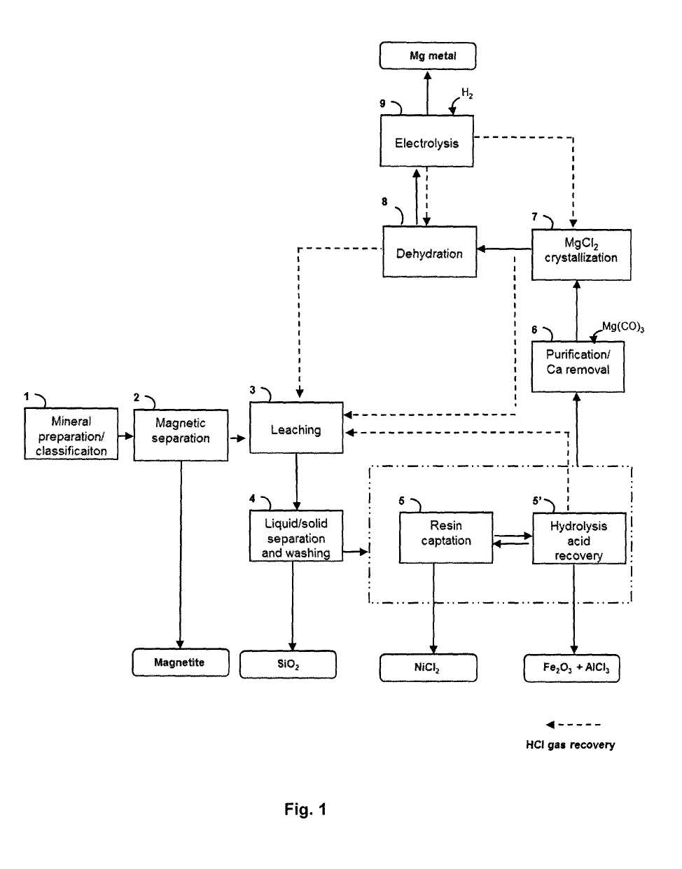

As can be seen from FIG. 1, and according to one embodiment, the process comprises a first step of preparing and classifying the mineral starting material.

### Preparation and Classification (Step 1)

The raw material can be mined above ground, adjacent to a plant. The serpentine from the pile is loaded to trucks and delivered to stone crushers for mechanical conditioning.

Tailing, and particularly asbestos tailing, can be finely crushed in order to help along during the following steps. The mining tailing is reduced to an average particle of about 50 to 80 μm. The tailing has to be crushed sufficiently to eliminate fibers present in asbestos tailings. For example, micronization can shorten the reaction time by few hours (about 2 to 3 hours). Screen classifiers can be used to select oversized pieces that can be re-crushed if necessary.

### Magnetic Separation (Step 2)

The magnetic separation provide a way to remove a large part of the magnetite. This magnetite is dispose and will not be submitted to the further leaching step. This step provide an efficient way to reduce hydrochlorique acid consumption. After the initial mineral separation (step 1), the crushed tailing undergoes a magnetic separation (step 2) to selectively recover magnetite. The yield of iron removal can reach over 90%.

### Acid Leaching (Step 3)

The crushed classified tailing then undergoes acid leaching. Acid leaching comprises reacting the crushed classified tailing with a hydrochloric acid solution during a given period of time which allows dissolving the magnesium and other elements like iron and nickel. The silica remains totally undissolved after leaching.

In an embodiment, it is encompassed that the tailing residue be leached at a temperature of about 60 to about 125° C., more specifically of about 80° C. These conditions are possible due to the high salt content in the reaction mixture preventing aqueous solution from boiling. Particularly, the tailing/acid ratio can be of about of 1:10 (weight/volume), the HCl concentration can be of about 25 to about 45 weight %, and the reaction time can be of about 1 to about 7 hours. The leaching reaction converts most magnesium, iron, potassium, calcium, nickel and manganese into water-soluble chloride compounds. A significant portion of the alumina and all the silica are inert to HCl digestion and remain solid in the reaction mixture.

### Liquid/Solid Separation and Washing (Step 4)

Once the extraction is terminated, the solid can be separated from the liquid by decantation and/or by filtration, after which it is washed. The residual leachate and the washing water may be completely evaporated.

The corresponding residue can thereafter be washed many times with water so as to decrease acidity and to lower the quantities of sodium hydroxide (NaOH) that are required during this step.

At this stage, a separation and cleaning step can be incorporated in order to separate the purified silica from the metal chloride in solution. For example, a filtration system consisting of a set of band filters operated under vacuum can be used. The band filter allows filtration of silica in a continuous mode. Pure silica (SiO₂) is recuperated. The recovered highly pure silica can then be used in the production of glass for example.

In an embodiment, the process can comprise separating the solid from the leachate and washing the solid so as to obtain silica having a purity of at least 90%.

### Resin Captation (Step 5) and Hydrolysis Recovery (Step 5′)

The spent acid (leachate) containing the metal chloride in solution obtained from step 3 can then be passed on a set of ion exchange resin beds comprising a chelating resin system to catch specifically the nickel chloride (NiCl₂). For example, the DOWEX™ M4195 chelating resin can be used for recovering nickel from very acidic process streams. Removal of nickel from water and organic solvents is fairly common using strong acid cation resins. Method of recovering nickel from high magnesium-containing Ni—Fe—Mg lateritic ore are also described in U.S. Pat. No. 5,571,308. Furthermore, pure nickel (Ni) can be obtained by electrolysis once the nickel chloride has been extracted. Nickel can also be precipitated at this stage as hydroxide, filtered in a filter press and sold for a value.

Iron chloride (contained in the liquid obtained from steps 4 or 5) can then be pre-concentrated and hydrolyzed (step 5′) at low temperature in view of the Fe₂O₃ (hematite form) extraction and acid recovery from its hydrolysis. The process can be effective for removal of Fe₂O₃ and AlCl₃.

In an embodiment, the iron chloride is extracted after the nickel has been captured on the resin as described above. Alternatively, the iron chloride can be pre-concentrated and hydrolyzed before the leachate is further passed on the chelating resin. The hydrolysis reaction consists in the conversion of iron chloride to hematite, producing HCl:H₂O vapor which can be recovered.

The hydrolysis is conducted at a temperature between 155-350° C. and Fe₂O₃ (hematite) is being produced and hydrochloric acid of at least 15% concentration is being regenerated. The method used can be for example as basically described in WO 2009/153321 (which is hereby incorporated by reference in its entirety), consisting in processing the solution of ferrous chloride and ferric chloride, possible mixtures thereof, and free hydrochloric acid through a series of pre-concentration step and oxidation step where ferrous chloride is oxidized into ferric form. It follows a hydrolysis step into a hydrolyser where the ferric chloride concentration is maintained at 65 weight % to generate a rich gas stream where concentration ensures a hydrogen chloride concentration of 15-20.2% and a pure hematite that will undergo a physical separation step.

In an embodiment, the liquid leachate can be concentrated to a concentrated liquid having an iron chloride concentration of at least 30% by weight; and then the iron chloride can be hydrolyzed at a temperature of about 155 to about 350° C. while maintaining a ferric chloride concentration at a level of at least 65% by weight, to generate a composition comprising a liquid and precipitated hematite, and recovering the hematite.

Alternatively, removal of iron can be carried out by using an extracting agent and a hollow fiber membrane. Various extracting agents that could substantially selectively complex iron ions could be used. For example, extraction can be carried out by using HDEHP (or DEHPA) di(2-ethylhexyl)phosphoric acid) as an extracting agent adapted to complex iron ions. A concentration of about 1 M of HDEHP can be used in an organic solvent, such as heptane or any hydrocarbon solvent. Such an extraction can require relatively short contact times (few minutes). For example, the pH of the order of 2 can be used and aqueous phase/organic phase ratio can be of about 1:1. It was observed that it is possible to extract from 86% to 98% iron under such conditions, iron which is trapped in the organic phase. To recover iron in an aqueous phase, a reverse extraction with hydrochloric acid (2 M or 6 M) and organic phase/acidic phase ratio of about 1:0.5 can then be carried out. In such a case, the resulting aqueous phase is rich in Fe³⁺ ions.

Further alternatively, removal of iron can also be carried out by resin absorption as known in the art.

The mother liquor left from the hydrolyser, after iron removal, is rich in other non-hydrolysable elements and mainly comprises magnesium chloride or possible mixture of other elements.

In addition, the processes can further comprise precipitating K₂SO₄, or Na₂SO₄ by adding for example H₂SO₄.

In an embodiment, it is provided that the liquid leachate can be concentrated to a concentrated liquid having an iron chloride concentration of at least 30% by weight; and then the iron chloride can be hydrolyzed at a temperature of about 155 to about 350° C. while maintaining a ferric chloride concentration at a level of at least 65% by weight, to generate a composition comprising a liquid and precipitated hematite; recovering the hematite; and reacting the liquid with HCl. Further, such process can further comprise reacting the liquid with H₂SO₄ so as to substantially selectively precipitate K₂SO₄ or Na₂SO₄.

Other non-hydrolysable metal chlorides (Me-Cl), such as MgCl₂ and others, which are still in the solution and have not been precipitated and recuperated, can then undergo the following steps.

### Purification/Ca Removal (Step 6)

The resulting solution rich in magnesium can next undergo a purification step 6 wherein MgCO₃ (or alternatively or in addition H₂SO₄ or MgSO₄) is supplemented to recuperate the undesirable CaCO₃ or CaSO₄.

### MgCl₂ Crystallization (Step 7)

The solution rich in magnesium chloride (or not) and other non-hydrolysable products can then be brought up in concentration with dry and highly concentrated gaseous hydrogen chloride by sparging it into a crystallizer. This can result into the precipitation of magnesium chloride as a hydrate.

After the crystallization step 8, a relatively pure magnesium chloride solution is obtained following a solid/liquid separation by for example, filtration, gravity, decantation, and/or vacuum filtration. Further, hydrochloric acid at very high concentration is thus regenerated and brought back to the leaching step.

### Dehydration (Step 8)

The relatively pure magnesium chloride solution then undergoes a dehydration step, consisting for example in a two step fluidized bed (step 8) to essentially obtain an anhydrous magnesium chloride with a drying gas containing hydrochloric acid, thereby separating anhydrous magnesium chloride from the remaining water. The drying process is realized by heating gas to about 150 to 180° C. and the solution is fed to a concentrator to bring the magnesium chloride concentration up. The magnesium chloride gas-drying is carried out in two stages, targeting two molecules of hydration-water removal in each stage, so that the drying temperatures can be selected to optimize drying and minimize oxidation. Alternatively, the magnesium chloride hydrate can be dried by using a rotary kiln or a spray drier under an HCl gas atmosphere.

The dehydrated magnesium chloride can then be dissolved by molten salt electrolyte. During the fluidized bed two step (step 8), dry hydrochloric acid is added to proceed with the dehydration. In the fluid bed dryer, dry hydrogen chloride gas heated up to about 450° C. allows fluidization of the particles, producing magnesium chloride granules. The reason for this is to avoid three negative characteristics of the magnesium hydrolysis reaction:
1) It creates magnesium oxide, which will later be concentrated as sludge in the electrolysis cells, and will react with the graphite anodes and negatively affect the energy efficiency of the process.
2) Magnesium chloride is lost during the process.
3) The acid gases produced during the reaction must be handled.

In the process described herein, the drying stage takes place in a fluidized bed dryer. At this stage, magnesium chloride with six molecules of water is dried by hot air to MgCl₂*2H₂O.

MgCl₂*6H₂O→MgCl₂*4H₂O+2H₂O(g) T=117° C.

MgCl₂*4H₂O→MgCl₂*2H₂O+2H₂O(g) T=185° C.

The last stage of drying, to extract anhydrous magnesium chloride, is carried out by gaseous HCl drying at temperatures of about 330° C. This stage is performed with heated gaseous HCl because of the difficulty in preventing hydrolysis, and the desire to obtain solid and dry magnesium chloride with magnesium oxide qualities of about 0.1%. The use of gaseous HCl will fundamentally reduce the hydrolysis reactions, thus reducing the concentration of magnesium oxide in the product. In addition, opposite reactions to hydrolysis take place with HCl, which also reduce the magnesium oxide.

MgO+HCl(g)→MgOHCl

MgOHCl+HCl(g)→MgCl₂(s)+H₂O(g)

The HCl from the drying process is transferred to the raw materials extraction and preparation process by passing through equipment used for the scrubbing of gaseous emissions. The resulting fluidizing gas contains hydrochloric acid which can be regenerated and brought back to the leaching step.

### Electrolysis (9)

Magnesium metal is then obtained by further electrolysis of the magnesium chloride (step 9).

Encompassed herein are processes for the electrolytic production of magnesium from magnesium chloride in an electrolytic cell having an anode and a cathode as described in U.S. application publication no. 2002/0014416, the content of which is incorporated herein by reference. The magnesium chloride are fed to electrolysis cells. An induction heater is used to bring the magnesium chloride to its melting point of about 700° C. The cells are operated under argon to maintain an inert atmosphere.

Accordingly, pure magnesium metal can be obtained by electrolytic production comprising the steps of electrolysing magnesium chloride obtained from the steps described hereinabove in a molten salt electrolyte in an electrolysis cell having a cathode and an anode, with formation of magnesium metal at the cathode, feeding hydrogen gas to the anode and reacting chloride ions at the anode with the hydrogen gas to form hydrogen chloride, recovering the magnesium metal from the cell, and recovering the hydrogen chloride from the cell.

The electrolysis cells are of monopolar or multipolar type. The electrolyte composition allows the magnesium metal produced to form a light phase floating on top of the electrolysis bath. The anode can be a high surface area anode, such as for example, a porous anode in which case an hydrogen gas permeates the pores of the anode, such as by diffusion, or molten electrolyte containing the magnesium chloride permeates the pores of the anode, to provide the contact between the hydrogen gas and the chloride ions. This novel design of the electrolytic anode allows the injection of hydrogen in the bath. The hydrogen gas may be fed along a non-porous tube or conduit to the porous anode. If this tube or conduit is in contact with the bath it should not be of a material which will function as an anode for the electrolysis.

Alternatively, any anode having a structure permitting delivery of hydrogen to the cell bath at the anode may be employed, such as for example but not limited to, an anode having drilled channels for communication with a source of hydrogen gas. Suitable anodes may be of graphite, silicon carbide or silicon nitride.

The hydrogen gas will then react with the native chlorine atoms on the surface of the electrode, where they are being created. This mechanism will produce dry hydrochloric acid gas directly at the electrode's surface and increases the cell's efficiency. Hydrogen diffusion anodes are known to be used for the electrochemical oxidation of hydrogen and/or electrochemical reduction of oxygen in hydrogen fuel cells, metal/air batteries, etc. Hydrogen diffusion anodes are typically constructed from high-surface-area carbon and fluorocarbon that is thermally sintered into or onto a planar substrate material. The use of a hydrogen diffusion anode provides a way to protect the carbon from oxidation by chlorine by providing the reducing H₂ gas at the interphase. The most interesting fact associated with the use of this type of anode is related to the overall chemistry reaction change into the cell and its related decomposition voltage compared with the conventional process.

MgCl₂→Mg+Cl₂ E=2.50V

MgCl₂+H₂→Mg+2HCl E=1.46V

In fact, the decomposition voltage can theoretically decreases by 1.04 volts, translating into approximately 30% less electricity consumption for magnesium production. Another major cost saving comes from the fact that the cell is producing HCl rather than chlorine, requiring no HCl synthesis plant.

Mixed oxides containing other non-hydrolysable components can then undergo a pyrohydrolysis reaction at 700-800° C. and recovered acid (15-20.2% wt.) can be rerouted for example to the leaching system

As seen in FIG. 1, multiple loops of reintroducing HCl recycled from the ongoing steps are present, demonstrating the capacity to recuperate the used HCl. For example, the process can be effective for providing an HCl recovery yield of at least 90%.

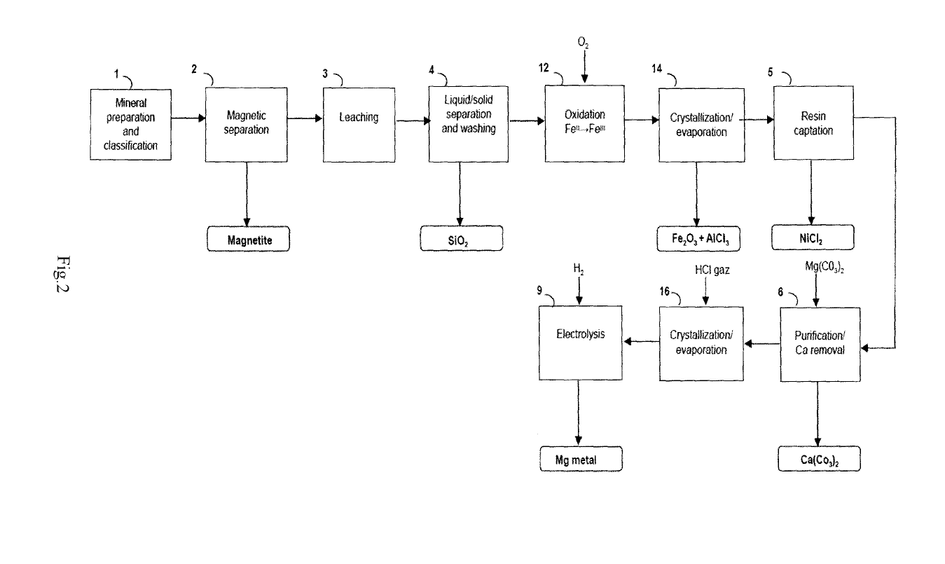

The process depicted in FIG. 1 can be supplemented with further steps as seen in FIG. 2.

Before the spent acid (leachate) containing the metal chloride actually passes through the resin captation in step 5 to recover the nickel chloride, it can first undergo an oxidation step 12 (converting iron state from Fe^{II} to Fe^{III}) and a crystallization/evaporation step 14 to recover Fe₂O₃ and AlCl₃.

Alternatively, a further crystallization/evaporation step 16 can also be added after the purification/removal step 6 of undesirable CaCO₃ or CaSO₄ before proceeding with the final electrolysis step 9 to recover the magnesium metal.

The present disclosure will be more readily understood by referring to the following example which is given to illustrate embodiments rather than to limit its scope.

### Example I

### MgCl₂ Extraction from Serpentine

The process described herein as been evaluated at the laboratory scale to confirm extraction of Mg from serpentine residues.

The sample were first dried 24 hrs at 110° C. in a conventional oven prior to be sieved and crushed with a mortar and pestle. The pre-treatment procedure produced 350 gr. of pebbles and 540 gr. of fines. The pebbles couldn't be crushed by hand and were not used for the experiments. Only the fines were used for the experiments.

The fines obtained after sieving and crushing were mixed and a 10 gr. sample was sent for analysis to AGAT laboratories to undergo an HCl/HNO₃ digestion. All liquid samples sent to AGAT laboratories are analyzed by ICP-MS. The extent of magnetite separation from serpentine has been evaluated. Both the magnetic solid part and the non-magnetic solid part have been sent to AGAT for metals analysis.

Two experiments (experiments #101 and 102, see Table 1) were run to measure the leaching efficiency over leaching duration. The leaching durations used were 2 hours and 4 hours. The leaching temperature was set at 120° C. One leaching experiment (experiment #103) was run at 80° C. (almost no heating) during 2 hours. The serpentine used for this experiment underwent magnetic separation. All experiments used the following proportions: 50 gr. serpentine, 64 mL H₂O and 89 mL HCl 12 M. This HCl/H₂O solution corresponds to a 23 wt % HCl solution. At the end of the leaching duration, the solid-liquid suspension was filtered and the filter cake fully washed. The lixiviate and the wash water were combined together prior to thermal hydrolysis.

TABLE 1
Summary of leaching experiments

| experi- | | leaching | | | | HCl |
|---|---|---|---|---|---|---|
| ment | magnetic | temper- | leaching | serpentine | H2O | 12M |
| no | separation | ature | time | mass | volume | volume |
| 101 | no | 120° C. | 4 hrs | 50 gr | 64 mL | 89 mL |
| 102 | no | 120° C. | 2 hrs | 50 gr | 64 mL | 89 mL |
| 103 | yes | 80° C. | 2 hrs | 50 gr | 64 mL | 89 mL |

The leaching liquid product (lixiviate+wash water) was put into a flask equipped with a dean stark and a condenser. The concentration, oxidation and thermal hydrolysis all occurred in a one-pot synthesis, The heating bath was set at 200-230° C. right at the start. The reaction lasted 8 hours at 200-230° C.

Table 2 show the main components of the untreated serpentine ore.

TABLE 2
Main components of the untreated serpentine ore

| | sample 1 | sample 2 | sample 3 | sample 4 | average | std deviation |
|---|---|---|---|---|---|---|
| component | ppm | ppm | ppm | ppm | ppm | % |
| 4-acid digest ICP/ICP-MS | | | | | | |
| Ca | 5 900 | 1 300 | 2 300 | 300 | 2 450 | 100% |
| Co | 87 | 93 | 94 | 109 | 96 | 10% |
| Cr | 505 | 826 | 554 | 1 250 | 784 | 44% |
| Fe | 36 200 | 35 600 | 41 300 | 55 400 | 42 125 | 22% |
| K | 3 400 | 400 | 800 | 100 | 1 175 | 129% |
| Mg | 181 000 | 235 000 | 223 000 | 229 000 | 217 000 | 11% |
| Mn | 761 | 845 | 806 | 599 | 753 | 14% |
| Ni | 1 640 | 1 990 | 1 890 | 2 090 | 1 903 | 10% |
| P | 110 | 45 | 51 | 15 | 55 | 72% |
| Na2O2 fusion ICP-OES | | | | | | |
| Al | 13 800 | 4 900 | 5 800 | 3 100 | 6 900 | 69% |
| Si | 203 000 | 167 000 | 173 000 | 154 000 | 174 250 | 12% |

Table 3 is a summary of the calculation results for the required HCl consumption based on the protocol described in Table 1.

TABLE 3
HCl consumption for a 50 gr. serpentine sample

| | | | 50-g sample | 50-g sample | HCl required |
|---|---|---|---|---|---|
| component | MW | valency | mg | mmol | mmol |
| 4-acid digest | | | | | |
| ICP/ICP-MS | | | | | |
| Ca | 40 | 2 | 123 | 3 | 6 |
| Co | 59 | 2 | 5 | 0 | 0 |
| Cr | 52 | 2 | 39 | 1 | 2 |
| Fe | 56 | 3 | 2 106 | 38 | 113 |
| K | 39 | 1 | 59 | 2 | 2 |
| Mg | 24 | 2 | 10 850 | 452 | 904 |
| Mn | 55 | 2 | 38 | 1 | 1 |
| Ni | 59 | 2 | 95 | 2 | 3 |
| P | 31 | — | 3 | 0 | — |
| NaOH fusion | | | | | |
| ICP-OES | | | | | |
| Al | 27 | 3 | 345 | 13 | — |
| Si | 28 | 4 | 8 713 | 311 | — |

The magnetic separation of serpentine efficiency is summarized in Table 4.

TABLE 4
Mass balance on magnetic separation of serpentine

| | as-received | | non magnetic | | magnetic | |
|---|---|---|---|---|---|---|
| component | serpentine | | serpentine | | serpentine | |
| ICP-MS | 101-0 | | 103-2 | | 103-1 | |
| analysis | mg (ppm) | | mg (ppm) | | mg (ppm) | |
| Al | 46 | (933) | 71 | (1620) | 5 | (971) |
| Ca | 16 | (325) | 41 | (943) | 1 | (219) |
| Cr | 21 | (435) | 19 | (445) | 1 | (328) |
| Co | 4 | (81) | 3 | (72) | 0 | (88) |
| Fe | 1890 | (37800) | 1161 | (26400) | 798 | (133000) |
| K | 5 | (100) | 4 | (100) | 0 | (100) |
| Mg | 8550 | (171000) | 8228 | (187000) | 942 | (157000) |
| Mn | 34 | (681) | 30 | (683) | 4 | (690) |
| Ni | 91 | (1820) | 77 | (1760) | 10 | (1770) |
| Zn | 7 | (150) | 10 | (229) | 0 | (150) |

Tables 5 to 7 summarize the leaching experiments at 120° C. and 80° C. as a function of leaching time.

TABLE 5
Mass balance on serpentine leaching at 120°
C., 23 wt %, HCl 2 hr (exp#102)

| | | | | | | | ex- |
|---|---|---|---|---|---|---|---|
| component | serpentine | | lixiviate | | silica | | trac- |
| ICP-MS | 101-0 | | 102-1 | | 102-2 | | tion |
| analysis | mg (ppm) | | mg (ppm) | | mg (ppm) | | % |
| Al | 46 | (933) | 63 | (201) | 7 | (320) | |
| Ca | 16 | (325) | 31 | (100) | 8 | (376) | |
| Cr | 21 | (435) | 25 | (82.1) | 1 | (78) | |
| Co | 4 | (81) | 4 | (13) | 0 | (15) | |
| Fe | 1890 | (37800) | 2387 | (7580) | 96 | (4090) | 120% |
| K | 5 | (100) | 7 | (23) | 2 | (100) | |
| Mg | 8550 | (171000) | 9481 | (30100) | 267 | (11400) | 106% |
| Mn | 34 | (631) | 37 | (118) | 0 | (30) | |
| Ni | 91 | (1820) | 91 | (290) | 1 | (47) | 100% |
| Zn | 7 | (150) | 13 | (41.8) | 2 | (100) | |

TABLE 6
Mass balance on serpentine leaching at 120°
C., 23 wt %, HCl 4 hr (exp#101)

| | | | | | | | ex- |
|---|---|---|---|---|---|---|---|
| component | serpentine | | lixiviate | | silica | | trac- |
| ICP-MS | 101-0 | | 101-1 | | 101-2 | | tion |
| analysis | mg (ppm) | | mg (ppm) | | mg (ppm) | | % |
| Al | 46 | (933) | 64 | (208) | 5 | (274) | |
| Ca | 16 | (325) | 33 | (107) | 5 | (238) | |
| Cr | 21 | (435) | 25 | (83.7) | 0 | (45) | |
| Co | 4 | (81) | 4 | (14) | 0 | (15) | |
| Fe | 1890 | (37800) | 2470 | (7970) | 80 | (3740) | 131% |
| K | 5 | (100) | 18 | (61) | 2 | (100) | |
| Mg | 8550 | (171000) | 9579 | (30900) | 220 | (10200) | 112% |
| Mn | 34 | (681) | 38 | (123) | 0 | (25) | |
| Ni | 91 | (1820) | 93 | (302) | 1 | (51) | 102% |
| Zn | 7 | (150) | 12 | (39) | 2 | (100) | |

TABLE 7
Mass balance on serpentine leaching at 80°
C., 23 wt %, HCl 2 hr (exp#103)

| | non magnetic | | | | | | ex- |
|---|---|---|---|---|---|---|---|
| component | serpentine | | lixiviate | | silica | | trac- |
| ICP-MS | 103-2 | | 103-3 | | 103-7 | | tion |
| analysis | mg (ppm) | | mg (ppm) | | mg (ppm) | | % |
| Al | 81 | (1620) | 74 | (186) | 12 | (518) | |
| Ca | 47 | (943) | 45 | (113) | 4 | (187) | |
| Cr | 22 | (445) | 21 | (53.2) | 2 | (117) | |
| Co | 3 | (72) | 3 | (9) | 0 | (15) | |
| Fe | 1320 | (26400) | 1444 | (3610) | 102 | (4270) | 109% |
| K | 5 | (100) | 2 | (5) | 2 | (100) | |
| Mg | 9350 | (187000) | 9800 | (24500) | 734 | (30600) | 105% |
| Mn | 34 | (683) | 31 | (78.4) | 1 | (78) | |
| Ni | 88 | (1760) | 88 | (220) | 3 | (147) | 100% |
| Zn | 11 | (229) | 10 | (25.1) | 2 | (100) | |

While the invention has been described in connection with specific embodiments thereof, it will be understood that it is capable of further modifications and this application is intended to cover any variations, uses, or adaptations of the invention, and including such departures from the present disclosure as come within known or customary practice within the art to which the invention pertains and as may be applied to the essential features hereinbefore set forth, and as follows in the scope of the appended claims.

1. A process for extracting magnesium metal from a magnesium-bearing material, said process comprising:
a. leaching the magnesium-bearing material with HCl as to obtain a leachate containing magnesium chloride; and
b. electrolyzing the magnesium chloride for extracting magnesium metal.

2. The process of claim 1, wherein the step of electrolyzing the magnesium chloride comprises using an electrolysis cell having a cathode and an anode wherein a source of hydrogen gas is delivered to the anode.

3. The process of claim 2, further comprising the step of dehydrating magnesium chloride contained in the leachate before the step of electrolyzing the leachate containing magnesium chloride to obtain magnesium metal.

4. The process of claim 3, wherein a two step fluidized bed is used for dehydrating the magnesium chloride.

5. The process of claim 4, further comprising a drying step in a fluidized bed dryer followed by gaseous HCl drying to extract anhydrous magnesium chloride.

6. The process of claim 5, wherein the dehydrated magnesium chloride is further dissolved in molten salt electrolyte.

7. The process of claim 1, wherein dry hydrochloric acid is added to proceed with the dehydration step.

8. The process of claim 1, further comprising recycling said gaseous HCl by contacting it with water so as to obtain a composition having a concentration of about 25 to about 45 weight % and using said composition for leaching.

9. The process of claim 8, wherein said magnesium-bearing material is leached with HCl having a concentration of about 20 to about 45 weight % at a temperature of about 60 to about 125° C.

10. (canceled)

11. The process claim 8, wherein said recycled gaseous HCl so-produced is contacted with water so as to obtain said composition having a concentration between 25 and 36 weight %.

12. (canceled)

13. The process of claim 1, further comprising the step of passing the leachate on a chelating resin system to recuperate nickel chloride from said leachate.

14. (canceled)

15. The process of claim 13, further comprising the step of electrolyzing the nickel chloride to obtain nickel.

16. The process of claim 1, further comprising the step of hydrolysis at low temperature of about 155 to about 350° C. the leachate to extract hematite.

17. The process of claim 16, further comprising the step of passing the hydrolyzed leachate on a chelating resin system to recuperate nickel chloride from said hydrolyzed leachate.

18. (canceled)

19. The process of claim 1, further comprising the step of supplementing at least one of MgCO₃, H₂SO₄, and MgSO₄ to the leachate and purifying said supplemented leachate to recuperate CaCO₃ and/or CaSO₄.

20. The process of claim 13, further comprising the step of separating a liquid phase from a solid form of the leachate and concentrating said liquid phase to a concentrated liquid having an iron chloride concentration of at least 30% by weight; and then said iron chloride is hydrolyzed at a temperature of about 155 to about 350° C. while maintaining a ferric chloride concentration at a level of at least 65% by weight, to generate a composition comprising a liquid and precipitated hematite, and recovering said hematite.

21. (canceled)

22. (canceled)

23. The process of claim 1, further comprising a step of magnetic separation of the magnesium-bearing material before step a) of leaching to recover magnetite.

24. The process of claim 1, further comprising the steps of oxidizing reacted leachate and crystallizing said reacted leachate to recover Fe₂O₃ and AlCl₃.

25. (canceled)

26. (canceled)

27. (canceled)

28. (canceled)

29. (canceled)

30. The process of claim 1, wherein the magnesium-bearing material is a magnesium-bearing ore.

31. (canceled)

32. The process of claim 1, wherein the magnesium-bearing material is an asbestos mine tailing.

33. (canceled)

34. (canceled)

35. (canceled)

36. (canceled)
